(19) United States
(12) Patent Application Publication
(10) Pub. No.: US 2025/0131036 A1
(43) Pub. Date: Apr. 24, 2025

(54) COMPUTER SYSTEMS AND METHODS FOR MANIFOLD LEARNING

(71) Applicant: Discover Financial Services, Riverwoods, IL (US)

(72) Inventors: Shay Deutsch, Los Angeles, CA (US); Arjun Ravi Kannan, Buffalo Grove, IL (US); Lionel Yelibi, Houston, TX (US)

(21) Appl. No.: 18/489,635

(22) Filed: Oct. 18, 2023

(51) Int. Cl. G06F 16/901; G06F 16/906

(52) U.S. Cl. CPC G06F 16/9024; G06F 16/906; G06F 18/2131; G06F 18/2137

(57) ABSTRACT

A computing platform may be configured to: (i) based on a set of data points defining a feature space, construct a graph structure associated with the set of data points; (ii) generate a multi-scale representation that represents the feature space, wherein each feature of a plurality of features from the feature space is represented in a respective plurality of scales with respect to the graph structure; (iii) regularize the multi-scale representation; (iv) based on the regularized multi-scale representation, identify a plurality of clusters associated with the set of data points; and (v) transmit, to a client station, data regarding the plurality of clusters and thereby cause an indication of the plurality of clusters to be presented at a user interface of the client station.

### BACKGROUND

An increasing number of technology areas are becoming driven by data and the analysis of such data to develop insights. One way to do this is with data science models that may be created and then applied to data to derive insights such as describing outcomes or predicting future outcomes (e.g., describing customer behavior or predicting future customer behavior).

In many cases, analysis of data to develop insights may involve utilizing data science models configured to segment data, such data science models that apply clustering technology. Various methods of clustering exist, including, for instance, K-means clustering, hierarchical clustering, affinity propagation (AP) clustering, mean shift clustering, and gaussian mixture model (GMM) clustering. These existing clustering methods such as K-means clustering, hierarchical clustering, AP clustering, mean shift clustering, and GMM clustering are typically fast and effective on data that involves a structure having well-separated clusters; however, these existing clustering methods are typically less useful when complex patterns exist in the data (e.g., when the separation boundary is nonlinear or a large amount of noise exists in data).

Further, existing approaches to clustering may also involve nonlinear dimensionality reduction (also commonly referred to as “manifold learning”). More particularly, in the context of clustering, nonlinear dimensionality reduction may be utilized as a pre-processing step which may be employed before clustering can be applied effectively. Nonlinear dimensionality reduction refers to various related techniques that aim to project high-dimensional data onto lower-dimensional latent manifolds. Nonlinear dimensionality reduction methods typically involve graph-based methods, and existing nonlinear dimensionality reduction methods can be effective in reducing the dimensionality of data attributes into a nonlinear lower dimensional representation while improving their capacity to retain relations between the data. Nonlinear dimensionality reduction may also help to visualize data in the low-dimensional space. One common example of a nonlinear dimensionality reduction method is Uniform Manifold Approximation and Projection (UMAP). Existing manifold learning techniques, such as UMAP, typically employ nonlinear dimensionality reduction to reduce the dimensions of the output embedding space.

In some scenarios, such existing manifold learning techniques may help to improve clustering results. However, while existing manifold learning approaches may help to improve clustering results in some scenarios, existing manifold learning approaches also suffer from issues where data is complex and/or has a large amount of noise. Furthermore, existing manifold learning approaches also have limited interpretability as to original feature dimensions of the data.

### OVERVIEW

Disclosed herein is new software technology for manifold learning and improved interpretability of clustering results.

In one aspect, the disclosed technology may take the form of a method to be carried out by a computing platform that involves: (i) based on a set of data points defining a feature space, constructing a graph structure associated with the set of data points; (ii) generating a multi-scale representation that represents the feature space, wherein each feature of a plurality of features from the feature space is represented in a respective plurality of scales with respect to the graph structure; (iii) regularizing the multi-scale representation; (iv) based on the regularized multi-scale representation, identifying a plurality of clusters associated with the set of data points; and (v) transmitting, to a client station, data regarding the plurality of clusters and thereby causing an indication of the plurality of clusters to be presented at a user interface of the client station.

In an example, the graph structure comprises a graph Laplacian, and generating a multi-scale representation that represents the feature space, wherein each feature of a plurality of features from the feature space is represented in a respective plurality of scales with respect to the graph structure comprises (i) computing coefficients corresponding to a polynomial approximation for a Spectral Graph Wavelets (SGW) transform of the graph Laplacian and (ii) initializing multi-scale graph embedding coordinates for the multi-scale representation by computing a respective SGW for each coordinate dimension.

In an example, the multi-scale representation represents signal of the multi-scale representation in a vertex domain and a spectral domain.

In an example, regularizing the multi-scale representation comprises optimizing features of the multi-scale representation by using stochastic gradient descent with respect to the graph structure.

In an example, regularizing the multi-scale representation comprises, for each respective feature of the multi-scale representation, (i) concatenating scales and feature dimensions corresponding to the respective feature and (ii) optimizing the respective feature of the multi-scale representation using the concatenated scales and feature dimensions corresponding to the respective feature.

In an example, regularizing the multi-scale representation comprises, for each respective feature of the multi-scale representation: for each respective scale of the multi-scale representation, (i) concatenate feature dimensions corresponding to the respective feature and (ii) optimize the respective feature for the respective scale using the concatenated feature dimensions corresponding to the respective feature.

In an example, based on the regularized multi-scale representation, identifying a plurality of clusters associated with the set of data points comprises using an unsupervised machine learning model to output the plurality of clusters.

In an example, (i) the feature space comprises a plurality of original points, (ii) each original point is associated with a plurality of feature dimensions, (iii) the regularized multi-scale representation comprises a plurality of coordinates, (iv) each respective coordinate in the regularized multi-scale representation is associated with a corresponding feature dimension of the feature space, and (v) the method further comprises, based on the plurality of clusters and the corresponding feature dimensions associated with the coordinates of the regularized multi-scale representation, deriving one or more insights for the plurality of clusters.

In an example, based on the plurality of clusters and the corresponding feature dimensions associated with the coordinates of the regularized multi-scale representation, deriving one or more insights for the plurality of clusters comprises, for each respective cluster of the plurality of clusters, identifying one or more feature dimensions from the feature space that have a threshold level of significance for the respective cluster.

In an example, the method further comprises, for each respective coordinate in the regularized multi-scale representation, identifying a respective corresponding feature dimension of the feature space associated with the respective coordinate. Further, in this example, regularizing the multi-scale representation to, based on the plurality of clusters and the corresponding feature dimensions associated with the coordinates of the regularized multi-scale representation, derive one or more insights for the plurality of clusters comprises, based on the plurality of clusters and the identified corresponding feature dimensions of the feature space associated with the respective coordinates, derive the one or more insights for the plurality of clusters.

In an example, based on the plurality of clusters and the corresponding feature dimensions associated with the coordinates of the regularized multi-scale representation, deriving one or more insights for the plurality of clusters comprises (i) for each respective cluster, assigning a clustering label to the respective cluster and (ii) using the assigned clustering labels to derive the one or more insights for the plurality of clusters.

In an example, the coordinates of the regularized multi-scale representation comprise regularized wavelet coefficients, and using the assigned clustering labels to derive the one or more insights for the plurality of clusters comprises (i) determining Shapley values of the regularized wavelet coefficients by using the assigned clustering labels and employing a Shapley algorithm to the regularized multi-scale representation and (ii) based on the determined Shapley values and the corresponding original feature dimensions associated with the coordinates of the regularized multi-scale representation, identifying, for each respective cluster of at least a subset of the plurality of clusters, respective one or more original features from the original feature space that have a threshold level of significance for the respective cluster.

In an example, the method further comprises transmitting, to a second client station, data defining the one or more insights and thereby cause an indication of the one or more insights to be presented at a user interface of the second client station.

In an example, the client station and the second client station are the same client station.

In an example, the indication of the plurality of clusters and the indication of the one or more insights are presented at a same time.

In yet another aspect, disclosed herein is a computing platform that includes a communication interface, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In still another aspect, disclosed herein is a non-transitory computer-readable medium provisioned with program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts a simplified block diagram illustrating an example computing environment, according to aspects of the disclosed technology.

FIG. 2 depicts a flow diagram of an example process for a manifold learning approach to unsupervised learning, according to aspects of the disclosed technology.

FIG. 3A illustrates a visualization of an example data set.

FIG. 3B illustrates a visualization of the example data set of FIG. 3A with ground truth labels.

FIG. 3C illustrates visualizations of example Spectral Graph Wavelets (SGW) associated with the data set of FIG. 3A at a plurality of scales, according to an example in accordance with the disclosed technology.

FIG. 3D illustrates visualizations of example regularized SGW at a plurality of scales, according to an example in accordance with the disclosed technology.

FIG. 4A depicts an example snapshot of a graphical user interface (GUI) that may be presented to a user according to aspects of the disclosed technology.

FIG. 4B depicts an example snapshot of a GUI that may be presented to a user according to aspects of the disclosed technology.

FIG. 5 is a simplified illustration demonstrating correspondence between features of an original feature space and coordinates of a regularized multi-scale representation, according to aspects of the disclosed technology.

FIG. 6 depicts a flow diagram of an example process for interpreting clustering results, according to aspects of the disclosed technology.

FIG. 7A illustrates a visualization of example input data, according to an example.

FIG. 7B illustrates a visualization of example clustering results, according to an example.

FIG. 7C illustrates a visualization of example clustering results, according to an example in accordance with the disclosed technology.

FIG. 8A illustrates a visualization of example clustering results, according to an example.

FIG. 8B illustrates a visualization of example clustering results, according to an example in accordance with the disclosed technology.

FIG. 9A illustrates a visualization of example clustering results, according to an example.

FIG. 9B illustrates a visualization of example clustering results, according to an example in accordance with the disclosed technology.

FIG. 10A illustrates a visualization of example clustering results, according to an example.

FIG. 10B illustrates a visualization of example clustering results, according to an example in accordance with the disclosed technology.

FIG. 11A illustrates a visualization of example clustering results, according to an example.

FIG. 11B illustrates a visualization of example clustering results, according to an example in accordance with the disclosed technology.

FIG. 12 is a simplified block diagram that illustrates some structural components of an example computing platform.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

Organizations in various industries have begun to utilize data science models to derive insights that may enable those organizations, and the goods and/or services they provide, to operate more effectively and/or efficiently. The types of insights that may be derived in this regard may take numerous different forms, depending on the organization utilizing the data science model(s) and the type of insight(s) that are desired. As one example, an organization may utilize a data science model to predict the likelihood that an industrial asset will fail within a given time horizon, based on operational data for the industrial asset (e.g., sensor data, actuator data, etc.). As another example, data science models may be used in a medical context to predict the likelihood of a disease or other medical condition for an individual, and/or the result of a medical treatment for the individual.

As yet another example, many organizations have begun to utilize data science models to help understand customer behavior (e.g., current and/or predicted behavior of prospective and/or existing customers) and make certain business decisions based on customer behavior. For instance, as one possibility, an organization may utilize a data science model to predict behavior of a prospective customer and then decide whether to extend service provided by that organization to the prospective customer. One example may be an organization that provides financial services such as loans, credit card accounts, bank accounts, or the like, which may utilize a data science model to help make decisions regarding whether to extend one of these financial services to a particular individual (e.g., by estimating a risk level for the individual and using the estimated risk level as a basis for deciding whether to approve or deny an application submitted by the individual).

As another possibility, an organization may utilize a data science model to predict behavior of a prospective customer and then decide what terms to offer the prospective customer for a service provided by the organization, such as what interest rate level to offer the prospective customer for a new loan or a new credit card account.

As yet another possibility, an organization may utilize a data science model to predict behavior of a prospective customer and then determine whether to target the prospective customer when engaging in marketing of a good and/or service that is provided by the organization (e.g., by determining whether to individual is likely to utilize the good and/or service).

As still yet another possibility, an organization may utilize a data science model to predict behavior of an existing customer or a group of existing customers and take a given business action or actions based on the predicted behavior of the existing customer or group of existing customers.

In many scenarios, and as is common in the financial services industry, data to be analyzed by data science models are complex data sets. A complex data set has an intrinsic structure and patterns within the data. However, a complex data set may also have a lot of noise within the data set, and identifying the intrinsic structure and patterns within the complex data set may be a challenging exercise. Typically, as complexity of a data set increases, the more challenging it is to identify the intrinsic structure and patterns within the complex data set.

Data science models may be created and then applied to complex data sets to help understand customer behavior (e.g., current and/or predicted behavior of prospective and/or existing customers) and make certain business decisions based on customer behavior. In practice, a data science model may take the form of one or more machine learning models. Machine learning models may be created using various techniques including, for instance, supervised machine learning techniques and/or unsupervised machine learning techniques. Supervised machine learning techniques and unsupervised machine learning techniques have various advantages and disadvantages compared to one another.

Turning first to supervised learning techniques, machine learning models developed using supervised machine learning techniques may be effective in a scenario where labels for the data set are available or may be created (e.g., using human annotation). However, in practice, such development may be expensive and/or not practically possible when dealing with large and complex data sets. Further, supervised learning techniques are much less effective on tasks related to improving the representation of tabular data, which is typically the common data structure available for business applications associated with financial institutions. For example, the performance of deep learning methods are known to be much less effective in such cases for business applications associated with financial institutions.

On the other hand, developing machine learning models using unsupervised machine learning techniques may take place without using any labels and, as such, may be useful in analyzing complex data sets where labels are unavailable and/or are difficult or not practically possible to create. In some examples, machine learning models may be based on an unsupervised machine learning technique such as clustering, examples of which include K-means clustering, hierarchical clustering, affinity propagation (AP) clustering, mean shift clustering, and gaussian mixture model (GMM) clustering. However, existing clustering methods such as K-means clustering, hierarchical clustering, AP clustering, mean shift clustering, and GMM clustering are typically fast and effective on well-separated clusters but less useful when complex patterns exist in the data (e.g., when a separation boundary between clusters is nonlinear or a large amount of noise exists in data). Another challenge associated with these existing clustering techniques is inability or difficulty interpreting clusters resulting from the existing clustering techniques. For instance, it can be difficult to interpret the results of existing clustering techniques to determine which features in a complex data set contributed the most to the results.

In an effort to alleviate some of these problems with existing clustering techniques, machine learning models based on manifold learning techniques using graph embeddings methods have been developed. Such machine learning models may be based on unsupervised techniques and may be referred to herein as “manifold learning models utilizing graph embeddings methods”. Further, these manifold learning models utilizing graph embeddings methods may involve or be used in conjunction with existing clustering techniques. In some scenarios, manifold learning models utilizing graph embeddings methods may help to address some deficiencies of existing clustering techniques.

However, while existing manifold learning models utilizing graph embeddings methods may help address some deficiencies of existing clustering techniques in certain scenarios, developing robust methods for manifold learning models utilizing graph embeddings methods is still challenging for several reasons. For instance, one example challenge associated with manifold learning models utilizing graph embeddings methods is noisy data. In particular, without ground-truth labels, noise can be disruptive for existing manifold learning models utilizing graph embeddings methods.

Another example challenge associated with manifold learning models utilizing graph embeddings methods is computational complexity. In particular, manifold learning algorithms can be computationally intensive. In general, achieving a better approximation requires heavy computations and vice versa (e.g., faster algorithms sacrifice accuracy).

Yet another example challenge associated with manifold learning models utilizing graph embeddings methods is lack of, and adequate trade-off between, local and global methods. In this regard, manifold learning methods typically sacrifice learning global accuracy to accurately learn local structure, or vice versa. However, finding an effective and expressive representation to balance between learning local and global structure is challenging.

And still yet another example challenge associated with manifold learning models utilizing graph embeddings methods is interpretation. In existing manifold learning models utilizing graph embeddings methods, the original features of data used by manifold leaning methods are discarded. Thus, the output of the embedding space is not informative of the input feature space. More particularly, existing manifold learning algorithms have a limitation in that they do not explicitly maintain the relationship between the coordinates of the input features and the coordinates of the graph embeddings of existing manifold learning models. Thus, in existing manifold learning models utilizing graph embeddings methods, it is difficult to measure the importance of individual features with respect to the resulting manifold embeddings. This makes it challenging or impossible to identify which features are most relevant for describing the underlying structure of the data.

Some existing manifold learning models utilizing graph embeddings methods may address or solve a subset of these example challenges; however, existing manifold learning models utilizing graph embeddings methods fail to address all of these challenges. For instance, one common example of an existing manifold learning model utilizing graph embeddings methods is a model based on Uniform Manifold Approximation and Projection (UMAP). UMAP is commonly considered one of the modern, state-of-the-art methods for manifold learning. UMAP is often capable of helping to address the aforementioned computational complexity and tradeoff issues associated with existing manifold learning models utilizing graph embeddings methods. However, UMAP still suffers from significant challenges related to noisy data and interpretability. For instance, UMAP is often sensitive to noise and such noise can be disruptive. Further, the dimensions of the UMAP embedding space do not have a specific meaning with regard to the original feature space and, thus, UMAP lacks the ability to interpret complex data sets with respect to the original feature space.

To address these and other problems, disclosed herein is new software technology for manifold learning. The disclosed technology provides organizations with an improved way to analyze data sets and, in particular, generate clustering results for complex data sets and interpret clustering results for complex data sets. For instance, the disclosed technology provides a new manifold learning approach to unsupervised learning that optimizes the dimensionality of complex data structures in multiple resolutions, leading to improved clustering results. Further, the disclosed technology provides improved interpretability of clustering results by maintaining correspondence between original input features and features in the new representation space (i.e., identifying importance of individual features to the clustering results).

While existing manifold learning techniques, such as UMAP, typically predominantly employ nonlinear dimensionality reduction to reduce the dimensions of the output embedding space, the disclosed technology adopts a different approach that involves leveraging multi-scale graph representation to increase the dimensionality of the data, emphasizing enhanced data representation learning. Within examples, this disclosed approach can be most effectively utilized as a self-supervised learning technique. The disclosed approach excels not only in preserving both local and global structures-a traditional focus of manifold learning—but also in capturing meaningful patterns intrinsic to the underlying structure of the data. Consequently, the disclosed approach holds a broader applicability to downstream tasks when compared to leading conventional manifold learning methods (such as UMAP). While UMAP has applicability to and performs well in visualization tasks (and sometimes can be used for clustering), the disclosed approach retains such capability and provides enhanced benefits such as (i) enhanced data representation learning and (ii) improved interpretability of clustering results. In addition, the disclosed approach can also serve as a valuable tool for data visualization.

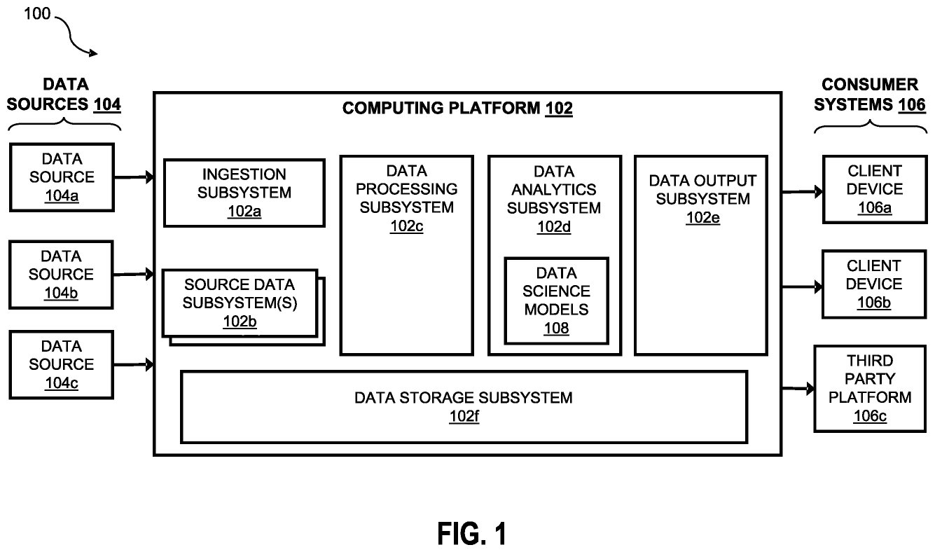

One illustrative example of a computing environment 100 in which the disclosed technology may be utilized is shown in FIG. 1. As shown, the example computing environment 100 may include a computing platform 102 associated with a given organization, which may comprise various functional subsystems that are each configured to perform certain functions in order to facilitate tasks such as data ingestion, data generation, data processing, data analytics, data storage, and/or data output. These functional subsystems may take various forms.

For instance, as shown in FIG. 1, the example computing platform 102 may comprise an ingestion subsystem 102a that is generally configured to ingest source data from a particular set of data sources 104, such as the three representative data sources 104a, 104b, and 104c shown in FIG. 1, over respective communication paths. These data sources 104 may take any of various forms, which may depend at least in part on the type of organization operating the example computing platform 102.

Further, as shown in FIG. 1, the example computing platform 102 may comprise one or more source data subsystems 102b that are configured to internally generate and output source data that is consumed by the example computing platform 102. These source data subsystems 102b may take any of various forms, which may depend at least in part on the type of organization operating the example computing platform 102.

Further yet, as shown in FIG. 1, the example computing platform 102 may comprise a data processing subsystem 102c that is configured to carry out certain types of processing operations on the source data. These processing operations could take any of various forms, including but not limited to data preparation, transformation, and/or integration operations such as validation, cleansing, deduplication, filtering, aggregation, summarization, enrichment, restructuring, reformatting, translation, mapping, etc.

Still further, as shown in FIG. 1, the example computing platform 102 may comprise a data analytics subsystem 102d that is configured to carry out certain types of data analytics operations based on the processed data in order to derive insights, which may depend at least in part on the type of organization operating the example computing platform 102. For instance, in line with the present disclosure, data analytics subsystem 102d may be configured to execute one or more data science models 108 configured to identify a plurality of clusters based on a regularized multi-scale representation. Data analytics subsystem 102d may also be configured to derive one or more insights based on the plurality of clusters and corresponding feature dimensions associated with coordinates of the regularized multi-scale representation.

Referring again to FIG. 1, the example computing platform 102 may also comprise a data output subsystem 102e that is configured to output data (e.g., processed data and/or derived insights) to certain consumer systems 106 over respective communication paths. These consumer systems 106 may take any of various forms.

For instance, as one possibility, the data output subsystem 102e may be configured to output certain data to client devices that are running software applications for accessing and interacting with the example computing platform 102, such as the two representative client devices 106a and 106b shown in FIG. 1, each of which may take the form of a desktop computer, a laptop, a netbook, a tablet, a smartphone, or a personal digital assistant (PDA), among other possibilities. These client devices may be associated with any of various different types of users, examples of which may include individuals that work for or with the organization (e.g., employees, contractors, etc.) and/or individuals seeking to obtain goods and/or services from the organization. As another possibility, the data output subsystem 102e may be configured to output certain data to other third-party platforms, such as the representative third-party platform 106c shown in FIG. 1.

In order to facilitate this functionality for outputting data to the consumer systems 106, the data output subsystem 102e may comprise one or more Application Programming Interface (APIs) that can be used to interact with and output certain data to the consumer systems 106 over a data network, and perhaps also an application service subsystem that is configured to drive the software applications running on the client devices, among other possibilities.

The data output subsystem 102e may be configured to output data to other types of consumer systems 106 as well.

Referring once more to FIG. 1, the example computing platform 102 may also comprise a data storage subsystem 102f that is configured to store all of the different data within the example computing platform 102, including but not limited to the source data, the processed data, the clustering results, and the one or more insights derived based on the clustering results and corresponding feature dimensions associated with coordinates of the regularized multi-scale representation. In practice, this data storage subsystem 102f may comprise several different data stores that are configured to store different categories of data. For instance, although not shown in FIG. 1, this data storage subsystem 102f may comprise one set of data stores for storing source data and another set of data stores for storing processed data and derived insights. However, the data storage subsystem 102f may be structured in various other manners as well. Further, the data stores within the data storage subsystem 102f could take any of various forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities.

The example computing platform 102 may comprise various other functional subsystems and take various other forms as well.

In practice, the example computing platform 102 may generally comprise some set of physical computing resources (e.g., processors, data storage, communication interfaces, etc.) that are utilized to implement the functional subsystems discussed herein. This set of physical computing resources take any of various forms. As one possibility, the computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the example computing platform 102 may comprise “on-premises” computing resources of the organization that operates the example computing platform 102 (e.g., organization-owned servers). As yet another possibility, the example computing platform 102 may comprise a combination of cloud computing resources and on-premises computing resources. Other implementations of the example computing platform 102 are possible as well.

Further, in practice, the functional subsystems of the example computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

It should be understood that computing environment 100 is one example of a computing environment in which embodiments described herein may be implemented. Numerous other arrangements are possible and contemplated herein. For instance, other computing configurations may include additional components not pictured and/or more or less of the pictured components.

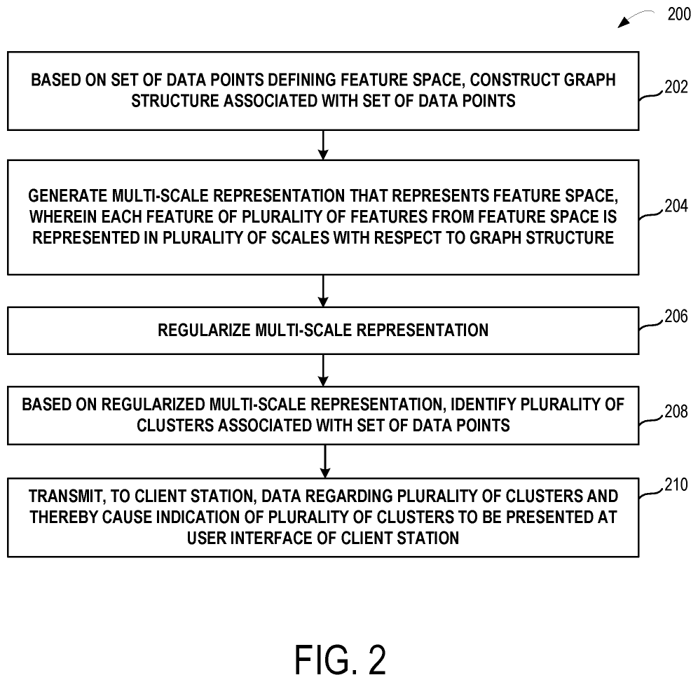

FIG. 2 depicts one example of a process 200 that may be carried out in accordance with the disclosed manifold-learning technology in order to generate a plurality of clusters associated with received data. For purposes of illustration only, example process 200 is described as being carried out by computing platform 102 of FIG. 1, but it should be understood that example process 200 may be carried out by computing platforms that take other forms as well. Further, it should be understood that, in practice, the functions described with reference to FIG. 2 may be encoded in the form of program instructions that are executable by one or more processors of computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As shown in FIG. 2, the example process 200 may begin at block 202 with computing platform 102 constructing, based on a set of data points defining a feature space, a graph structure associated with the set of data points. The set of data points defining a feature space (which may also be referred to herein as an “original feature space”) may be any suitable set of data points. In general, the set of data points may be related to various industries or fields including, for instance, financial services, industrial applications, scientific applications, or health care, among other possibilities.

Further, computing platform 102 may receive or obtain the set of data points in any suitable fashion, such as from one or more of data sources 104a-c. Still further, the set of data points may be a complex set of data points associated with a plurality of different dimensions. For instance, in an example, a given data set may define a feature space related to a plurality of points (e.g., individuals), where each individual is associated with a plurality of features (which may also be referred to as a dimension). More particularly, in such a data set, each data point may be associated with a number of features, where the dimensionality of each point is xᵢ∈R^{D}, where D=number of dimensions.

In practice, the number of dimensions will depend on the particular data set. Any suitable number of dimensions is possible. For instance, within examples, the number of dimensions may be a number within a range of 2-1.000. However, more dimensions are possible as well. In such data sets that have a plurality of dimensions, the data sets may have an interesting intrinsic complex structure. Further, constructing a graph structure associated with the set of data points helps to provide a flexible model to investigate complex interactions between data points which may not be captured by existing tools for clustering and manifold learning. In practice, it may be beneficial to have a number of data points in the data set that is at least as high as the number of dimensions/features associated with the data points. Such a balance between data points and dimensions may help make the disclosed process more effective for a given data set.

As a representative example of a complex data set representing a large number of data points and a plurality of dimensions, the “Census Income” data set from the UC Irvine Machine Learning Repository comprises data on approximately 49,000 individuals and 13 features, which include age, workclass, education, education-num, marital status, occupation, relationship, race, sex, capital gain, capital loss, hours-per-week, and native country. Other examples of complex data sets are possible as well. In this “Census Income” data set example, the data set achieves the desired balance between data points and dimensions (i.e., a number of data points that is at least as high as the number of dimensions associated with the data points). More particularly, in this “Census Income” data set example, the number of data points (i.e., approximately 49,000) is substantially higher than the number of dimensions (i.e., 13).

After receiving the set of data points, computing platform 102 may construct, based on a set of data points defining a feature space, a graph structure associated with the set of data points. In general, the function of constructing the graph structure associated with the set of data points may take various forms, one example of which is adaptive graph construction.

As an illustrative example of an adaptive graph construction (which may be referred to herein as a “graph construction illustrative example”), the input for graph construction may be a set of points x={xᵢ}, xᵢ∈R^{D}, i=1 . . . N, k nearest neighbor (kNN), and minimal distance ρ parameters. Further, the output may be G=(V,W), where V are the set of vertices in the graph and W=(w)_{i,j} are the set of edges in the graph. Computing platform 102 may use an adaptive graph construction as described below. Given xᵢ, computing platform 102 may construct a weighted graph W from a set of points as follows:

$${w}_{i \vert j} = {e}^{- \frac{d ( {x}_{i} , {x}_{j} ) - {ρ}_{i}}{{σ}_{i}}}$$

where an exponential probability distribution is used. In this example, the probabilities are not normalized. Further, ρᵢ is the distance from each i^{th} data point to its first nearest neighbor.

Computing platform 102 may then use matrix symmetrization:

$${w}_{ij} = {w}_{i \vert j} + {w}_{j \vert i} - {w}_{i \vert j} {w}_{j \vert i}$$

Matrix symmetrization is needed to use spectral methods which typically are more useful for symmetric similarity matrix. Computing platform 102 may then use the number of nearest neighbors based on:

$$k = {2}^{- {\sum }_{i} {w}_{ij}}$$

In this example, if the k nearest neighbor parameter (kNN) and minimal distance ρ (such that ρ≤ρᵢ for all i∈G) have low values (typically kNN<5), only local structure is retained and the global structure may not be preserved. Computing platform 102 may then compute the graph Laplacian L, and its largest eigenvalue λₘₐₓ(L).

It should be understood that this example adaptive graph construction is intended as an example only, and other ways of constructing a graph structure associated with the set of data points are possible as well including, for instance, other adaptive graph construction, kNN graph construction or e ball graph construction, among other possibilities.

Returning to FIG. 2, at block 204, computing platform 102 generates a multi-scale representation that represents the feature space, wherein each feature of a plurality of features from the feature space is represented in a respective plurality of scales with respect to the graph structure. For instance, in the graph construction illustrative example discussed above, the number of scales may be 5. However, in general, any suitable number of scales may be used. For instance, in an example, the number of scales is within a range of 2-10. However, a higher number of scales is possible as well. Further, within examples, the multi-scale representation represents signal of the multi-scale representation in a vertex (i.e., spatial) domain and a spectral domain.

In general, the multi-scale representation may be generated in various ways. As one possibility, computing platform 102 may generate the multi-scale representation based on a Spectral Graph Wavelets (SGW) transform. In order to represent each feature, each feature may be transformed using a set of basis functions corresponding to the SGW, a redundant representation of the feature using multiple scales with respect to the graph structure. SGW is a tool for multi scale signal representation on irregular graphs, which allows for simultaneously representing signal in the vertex and spectral domains. For instance, in an example where the graph structure comprises a graph Laplacian, generating the multi-scale representation may involve (i) computing coefficients corresponding to a polynomial approximation (e.g., a Chebyshev polynomial approximation) for a SGW transform of the graph Laplacian and (ii) initializing multi-scale graph embedding coordinates for the multi-scale representation by computing a respective SGW for each coordinate dimension.

As an illustrative example (and continuing the graph construction illustrative example discussed above), computing platform 102 may compute the coefficients {α_{e,i}}ᵢ₌₀^{K}, e=1, . . . m corresponding to the Chebyshev polynomial approximation ρ(λ) for the SGW transform. The parameters may include (i) m (representing the number of low and band pass filters (low pass corresponds to the scaling filter) and (ii) K (representing the highest order of the Chebyshev polynomial approximation which is used to approximate the SGW transform).

Computing platform 102 may then initialize multi-scale graph embeddings coordinates by computing the SGW for each coordinate dimension xₗ as follows:

For l=1, . . . D associated with the signals x={xₗ}:
(i) Take the spectral graph wavelet transform to obtain Ψₓ_{ₗ}(sₑ,:) at scales sₑ, e=1 . . . m; and
(ii) (ii) Concatenate all the computed spectral graph wavelet coefficients Ψₓ_{ₗ} (sₑ,:), e=1 . . . , m, in a matrix form denoted as Ψₓ.

In this example, the input x={xₗ}, l=1 . . . D, where x∈R^{N×D} is the matrix representation of the input signals/features xₗ∈R^{N}. Further, the output is Ψₓ∈R^{N×mD} (which represents the initial SGW embedding). Further, parameters include: (i) λₘₐₓ(L), which represents the largest eigenvalue of L; and (ii)

$${\{ {a}_{{s}_{e} , i} \}}_{i = 0}^{K} , e = 1 ,$$

m corresponding to the Chebyshev polynomial approximation ρ(λ) for the SGW transform.

In this example, xₗ can be chosen as either the input signals corresponding to the input features, or the smooth manifold coordinates associated with the graph smooth frequencies, for example those that correspond to the k eigenvectors associated with the smallest k eigenvalues of L. Further, Ψₓ_{ₗ} corresponds to vertex i concatenated SGW transform for all dimensions l=1, . . . D and all scales e=1 . . . m. Still further, Ψₓ_{ₗ}(sₑ,:) corresponds to the SGW transformation of feature dimension 1 with associated scale sₑ.

It should be understood that this example generation of a multi-scale representation using a Chebyshev polynomial approximation is intended as an example only, and other examples of generating the multi-scale representation that represents the feature space are possible as well.

Notably, multi-scale representations on graph and spectral graph wavelets provide tools to compactly capture smoothness of signals (features) with respect to the graph structure, which can be useful in separating noise from the signal features, as well as performing other tasks such as sampling. Further, an important utility of graph signal processing tools to the representation, analysis and processing of smooth manifolds is that most of the energy of the manifold dimensions is concentrated in the low frequencies of the graph. Manifolds with smoother characteristics lead to more energy concentrated in the lower frequencies of the graph spectrum. Additionally, higher frequency wavelet coefficients decay in a way that depends on smoothness properties of the manifold. In an example, when the manifold is contaminated with noise, the manifold smoothness properties induce a similar decay characteristic on the spectral wavelets transform of the noisy signal, assuming the noisy points are not too far away from their true local neighborhoods on the manifold.

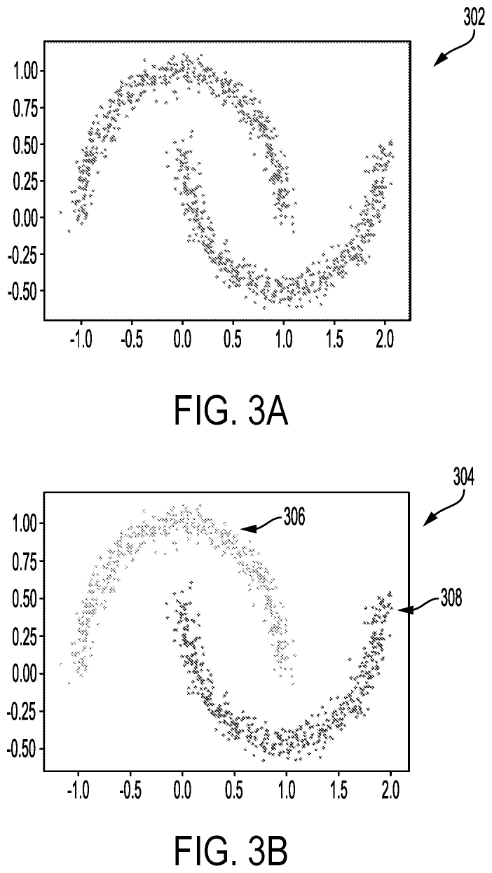

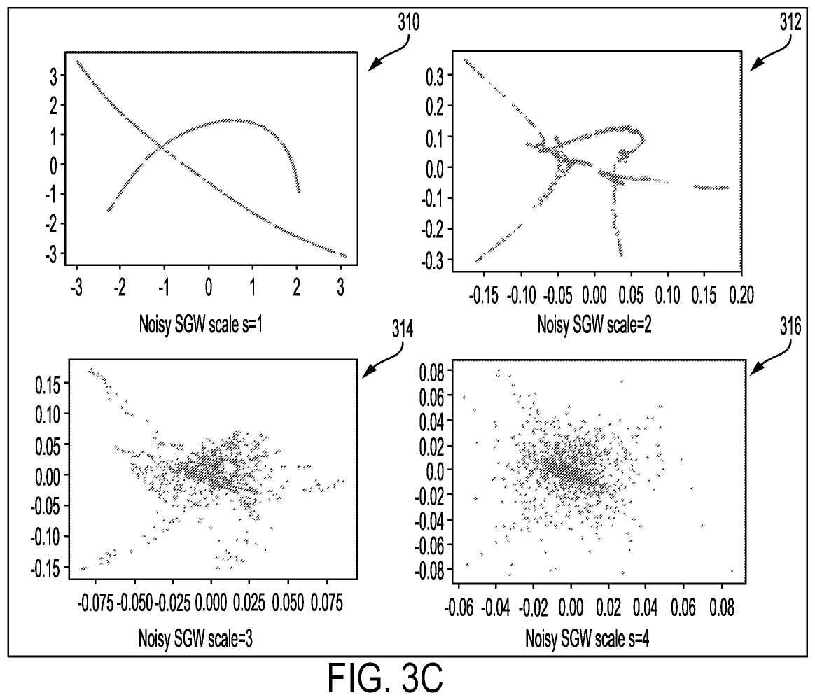

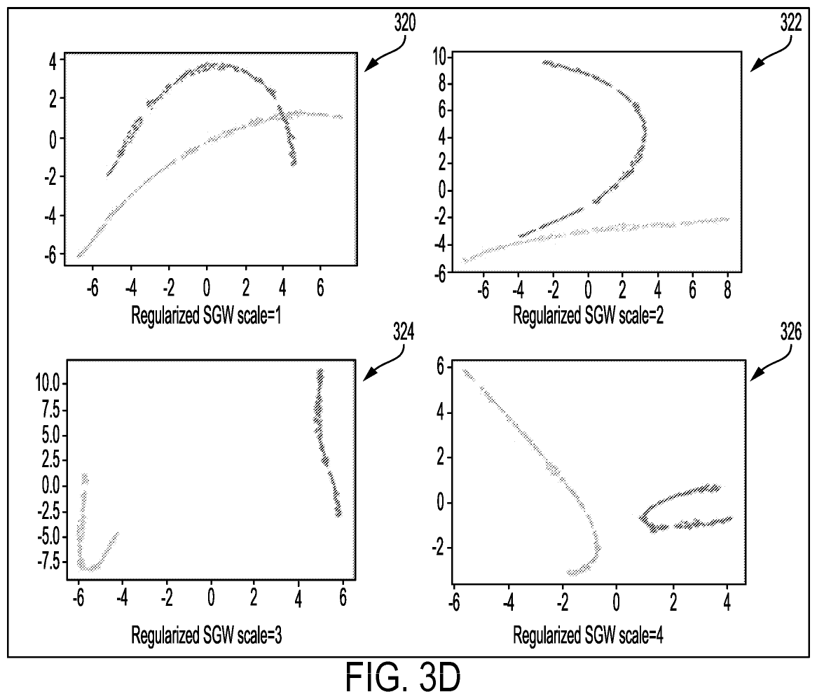

With reference to FIGS. 3A-C, representative examples of representation of data in a plurality of scales is described. In particular, FIG. 3A-illustrates a visualization 302 of an example data set (in particular, a “two moons” data set). Further, FIG. 3B illustrates a visualization 304 the data set of FIG. 3A with ground truth labels 306, 308. In particular, ground truth label 306 indicates data points corresponding to a first moon of the “two moons” data set, and ground truth label 308 indicates data points corresponding to a second moon of the “two moons” data set.

FIG. 3C illustrates a first visualization 310 of data at a first scale s=1, a second visualization 312 of data at a second scale s=2, a third visualization 314 of data at a third scale s=3, and a fourth visualization 316 of data of at a fourth scale s=4.

As can be seen from FIG. 3C, low frequency spectral wavelet coefficients show locally smooth behavior with respect to the coordinate signals that are spatially connected on the graph. However, the higher frequency bands (e.g., s=3 and s=4) are characterized by more noise.

It should be understood that these examples of representations at a plurality of scales are intended as examples only, and other representations at a respective plurality of scales are possible as well.

Returning to FIG. 2, at block 206, computing platform 102 regularizes the multi-scale representation. In general, regularizing the multi-scale representation (which may also be referred to herein as “optimizing the multi-scale representation”) may reduce the noise within the multi-scale representation.

By optimizing the multi-scale representation, information about the complex relationship of data in the graph structure can be extracted. As discussed above with respect to FIG. 3C, higher frequencies in a multi-scale representation may tend to have relatively more noise. However, while higher frequencies may have a larger amount of noise, these scales also contain important signal information and may help to reveal information about the complex relationship of data in the graph structure. Notably, the multi-scale representations of the disclosed technology are more expressive and richer than representations of existing manifold learning methods, which tend to discard or otherwise ignore this higher-noise information. As a result, more expressive and rich representations of the disclosed technology can help to extract more information about the signal and the complex relationship of data in the graph structure (compared to information that can be extracted from a representation of the existing manifold learning methods). In some conventional methods, in order to remove noise from a signal, a denoising method may be applied that involves removing noise from an input signal by projecting the signal back to an original space. In such conventional denoising methods, the input and output have the same dimensionality. For instance, in an example denoising method, an input may be a noisy 2D circle (or 3D sphere), and the output may be a 2D circle (or 3D sphere) that is as close as possible to a noise free 2D circle (or 3D sphere). On the other hand, in accordance with the disclosed technology, an example goal is to achieve better representation of the features (rather than merely denoising signals associated with unstructured, irregular graphs by projecting the signal back on the original space). This better representation is the multi-scale representation, which is a more rich representation in multiple scales that is ultimately concatenated and used for the downstream tasks described herein (e.g., such as clustering).

In general, the multi-scale representation may be regularized in various ways. Further, the disclosed regularization involves retaining the lower frequency components (which contain a large portion or most of the information in the signal) of the multi-scale representation without losing high frequency information of the multi-scale representation and separating it from noise.

As one possibility, computing platform 102 may regularize the multi-scale representation based on stochastic gradient descent (SGD) with respect to the graph structure. In this regard, regularizing the multi-scale representation based on SGD may take various forms, two examples of which are discussed in the following sections.

### i. First Example (Minimizing a Loss Function Using Concatenated Scales)

As a first example of regularizing the multi-scale representation based on SGD, computing platform 102 may, for each respective feature of the multi-scale representation, (i) concatenate scales and feature dimensions corresponding to the respective feature and (ii) optimize the respective feature of the multi-scale representation using the concatenated scales and feature dimensions corresponding to the respective feature. This example may be referred to herein as an “example of minimizing a loss function using concatenated scales.”

For instance, as an illustrative example of minimizing a loss function using concatenated scales (and continuing the graph construction illustrative example discussed above), computing platform 102 may construct embeddings by minimizing the following loss function using the output of Ψₓ:

$${l}_{loss} = {\sum }_{i , j} [ {w}_{ij} log \frac{{w}_{ij}}{{v}_{ij}^{{Ψ}_{x}}} + ( 1 - {w}_{ij} ) log \frac{1 - {w}_{i , j}}{1 - {v}_{ij}^{{Ψ}_{x}}} ] , where$$

$${v}_{ij}^{{Ψ}_{x}} = \frac{1}{1 + a {r}_{ij}^{2 b}}$$

$${r}_{ij} = ‖ {Ψ}_{{x}_{i}} - {Ψ}_{{x}_{j}} ‖$$

Further, the loss function can be optimized using gradient decent, where the gradient of the loss is given by:

$$\frac{\partial {l}_{loss}}{\partial {Ψ}_{{x}_{l}}} = {\sum }_{j} {w}_{ij} {v}_{ij}^{{Ψ}_{x}} ( {Ψ}_{{x}_{i}} - {Ψ}_{{x}_{j}} ) - {\sum }_{j} \frac{1}{1 + {r}_{ij}^{2}} {v}_{ij}^{{Ψ}_{x}} ( {Ψ}_{{x}_{i}} - {Ψ}_{{x}_{j}} )$$

In this example, the output is a regularized embedding space, [symbol] , where [symbol] ∈R^{N×mD}.

### ii. Second Example (Minimizing a Loss Function Using Concatenated Scales)

As a second example of regularizing the multi-scale representation based on SGD, computing platform 102 may, for each respective feature of the multi-scale representation, perform the following: for each respective scale of the multi-scale representation, (i) concatenate feature dimensions corresponding to the respective feature and (ii) optimize the respective feature for the respective scale using the concatenated feature dimensions corresponding to the respective feature. This example may be referred to herein as an “example of minimizing a loss function independently for each scale.”

For instance, as an illustrative example of minimizing a loss function independently for each scale (and continuing the graph construction illustrative example discussed above, prior to the discussion of the example of minimizing a loss function using concatenated scales), computing platform 102 may minimize a loss function independently for each scale sₑ, e=1, . . . m, associated with the filter bank g(sₑλ). Thus, computing platform 102 may optimize the loss independently with respect to different sizes of spatial neighborhood and for different spectral bands, as described below:

For l=1, . . . D associated with the signals x={xₗ}:
(iii) take the SGW transform to obtain Ψₓ_{ₗ}(sₑ,:) ∈R^{N} at scales sₑ, e=1, . . . m;
(ii) for each fixed scale sₑ, sₑ∈S, concatenate all the computed spectral graph wavelet coefficients Ψₓ_{ₗ}(sₑ,:) in a matrix form, which is denoted as Ψₓ(sₑ,:);
(iv) solve (for each scale sₑ):

$${l}_{loss} = {\sum }_{i , j} [ {w}_{ij} log \frac{{w}_{ij}}{{v}_{ij}^{{Ψ}_{x} ( {s}_{e} , : )}} + ( 1 - {w}_{ij} ) log \frac{1 - {w}_{ij}}{1 - {v}_{ij}^{{Ψ}_{x} ( {s}_{e} , : )}} ] , where$$

$${v}_{ij}^{{Ψ}_{x} ( {s}_{e} )} = \frac{1}{1 + a {r}_{ij}^{2 b}}$$

$${r}_{ij} = ‖ {Ψ}_{{x}_{i}} ( {s}_{e} , : ) - {Ψ}_{{x}_{j} ( {s}_{e} , : )} ‖$$

In the above, a and b are scalars and can be treated as hyper-parameters. Notably, in some examples, a and b can be chosen to be equal to 1 for simplicity (with insignificant or negligible effect on the quantitative results).

In this example, the loss function can be optimized using gradient decent, where the gradient of the loss is given by:

$$\frac{\partial {l}_{loss}}{\partial {Ψ}_{{x}_{l}} ( {s}_{e} )} = {\sum }_{j} {w}_{ij} {v}_{ij}^{{Ψ}_{x} ( {s}_{e} )} ( {Ψ}_{{x}_{i}} ( {s}_{e} ) - {Ψ}_{{x}_{j}} ( {s}_{e} ) ) - {\sum }_{j} \frac{1}{1 + {r}_{ij}^{2}} {v}_{ij}^{{Ψ}_{x} ( {s}_{e} )} ( {Ψ}_{{x}_{i}} ( {s}_{e} ) - {Ψ}_{{x}_{j}} ( {s}_{e} ) )$$

In this example, the output is the regularized embedding space for each scale:

$${s}_{e} , {¯}^{} ( {s}_{e} ) , e = 1 , … m .$$

Further, in this example, given the regularized [symbol] (sₑ), e=1, . . . m are concatenated in a matrix form [symbol] , computing platform 102 can take the inverse spectral wavelet transform to obtain the regularized features \tilde{x}, which provide the regularized features. Computing platform 102 can also apply the same inverse spectral graph wavelets transform to the output of the example of minimizing a loss function using concatenated scales (i.e., [symbol] ). However, the regularized embedding using the method of the example of minimizing a loss function independently for each scale was obtained by performing regularizing to the spectral graph wavelet coefficients independently with respect to each scale, which may help to improve the stability and robustness of the regularized signals compared to the example of minimizing a loss function using concatenated scales.

Since this second example applies regularization for each scale sₑ independently, this second example can be utilized to construct the final embeddings to be later used in downstream tasks. For example, if one wishes to use the output embedding of the regularized representation directly for clustering, computing platform 102 may use:

$$= ( {s}_{1} ) + ( {s}_{2} ) + … ( {s}_{m} )$$

As another example, computing platform 102 may more generally use:

$$= {\sum }_{i} {α}_{i} ( {s}_{i} ) .$$

In this example, αᵢ are coefficients which can be optimized based on some criteria, or chosen based on the tiling of the spectral domain with respect to each of the filters.

Other examples of regularizing the multi-scale representation are possible as well.

With reference to FIG. 3D, an illustrative example of visualizations of a regularized multi-scale representation at a plurality of scales is described. In particular, in this example, the SGW of FIG. 3C were regularized. FIG. 3D illustrates a first visualization 320 of the regularized SWG at a first scale s=1, a second visualization 322 of the regularized SWG at a second scale s=2, a third visualization 314 of the regularized SWG at a third scale s=3, and a fourth visualization 316 of the regularized SWG of at a fourth scale s=4. As can be seen by comparing FIGS. 3C and 3D, the regularized SGW of FIG. 3D have less noise than the noisy SGW of FIG. 3C.

In some examples, regularizing the multi-scale representation may involve sampling of edges within the graph structure. As used herein, an edge may correspond to a connection between nodes in the graph.

Various sampling approaches are possible. For example, some existing non-linear dimensionality reduction methods sample edges from the graph uniformly, without considering the relative importance of each node to the overall graph structure. As another possibility, computing platform 102 may be configured to use a sampling approach that takes into account not only edges but also edge importance. For instance, computing platform 102 may be configured to (i) for each respective edge of a plurality of edges of a representation, determine a respective measure of importance of the respective edge with respect to a structure of the representation; (ii) based on the measures of importance, select a set of edges from the plurality of edges to sample; and (iii) use the selected set of edges while regularizing the representation.

The respective measure of importance of an edge with respect to a structure of the representation may comprise an estimate of edge betweenness centrality (EBC), which may represent a fraction of shortest distance paths that pass through each edge. In this regard, edges with low EBC are often located in dense clusters of nodes in the graph structure, whereas edges with high EBC are often located in transition regions between clusters. Accordingly, an edge's EBC serves as an indicator of an edge's potential to serve as a bottleneck between clusters.

This disclosed sampling approach enables sampling more edges from dense clusters, which may be referred to as positive samples that connect similar nodes, and fewer edges from high betweenness centrality edges, which may be referred to as negative samples that connect dissimilar nodes. This sampling provides various benefits over existing sampling techniques. In this regard, the proposed sampling approach that takes into account not only edges but also edge importance (which may also be described as an “EBC sampling approach”) is not only based on local graph structure (i.e., within local clusters) but also provides good global information about the graph structure (i.e., connections between local clusters). However, existing sampling techniques heavily rely on the graph connectivity which only provides information on the local structure, thus ignoring the structural role of nodes in the graph.

Although this EBC sampling approach is described with respect to the disclosed multi-scale method, this sampling approach may be applied in other scenarios as well. For instance, this sampling approach could be applied to other manifold learning techniques, such as UMAP, among other possibilities.

As another possibility, computing platform 102 may be configured to use a diffusion-based sampling approach. In general, computing platform 102 may sample data points based on diffusion wavelets.

The proposed diffusion-based sampling approach utilizes diffusion wavelets to identify clusters of nodes showcasing denser interconnectivity within each cluster compared to connections outside it. This technique enhances the contrastive-based optimization process. The underlying approach encompasses two main principles. First, the approach employs delta functions to propagate diffusion wavelets from central nodes. These diffusion processes rely on spectral graph wavelets derived from the original graph structure. The resulting diffusion weights from each node are then consolidated in a matrix representation denoted as W_{Ψ}. Within this diffusion wavelet matrix, every column (indexed by i captures the diffusion spread from node i to its K-hop neighborhood). This matrix reveals insights into the mesoscale structures inherent in the graph network. The term “mesoscale structures” pertains to distinctive network features existing at an intermediate scale between the microscale (often denoting local structures, as observed in the 1-hop neighborhood feature of the graph Laplacian) and the macroscale (indicating global structures). Within a graph network, these mesoscale structures manifest as clusters or communities of nodes interconnected more densely internally than externally. These structures delineate functional subnetworks within the overall network structure.

The second facet of this approach involves harnessing the matrix to assess the spreading of diffusion wavelets across nodes. This matrix serves as a tool to calculate the distribution of diffusion wavelet spread for each node. Specifically, the diagonal entries of W_{Ψ}W_{Ψ}^{T} are utilized to accumulate statistics measuring the extent of diffusion spread among nodes. These statistics can be harnessed to refine the sampling strategy. For example, these statistics can guide the selection of nodes or edges for sampling, with a focus on nodes that demonstrate dense interconnectivity as well as nodes with comparatively sparser connections. By leveraging on this statistical insight, the sampling approach acquires a more sophisticated and informed comprehension of the network's fine-grain structure. This enhancement results in a more effective and precisely targeted node and edge selection process.

Other sampling approaches that may be used to regularize the multi-scale representation are possible as well.

Returning to FIG. 2, at block 208, computing platform 102 identifies, based on the regularized multi-scale representation, a plurality of clusters associated with the set of data points.

Computing platform 102 may identify the plurality of cluster in various ways. As one possibility, computing platform 102 may use an unsupervised machine learning model to output the plurality of clusters. In an example, the unsupervised machine learning model may apply a k-means clustering technique. Other unsupervised machine learning models are possible as well including, for instance, unsupervised machine learning models applying hierarchical clustering, AP clustering, mean shift clustering, and/or GMM clustering, among other possibilities.

At block 210 of FIG. 2, computing platform 102 transmits, to a client station, data regarding the plurality of clusters and thereby causes an indication of the plurality of clusters to be presented at a user interface of the client station. The indication of the plurality of clusters may take various forms. As one possibility, the indication of the plurality of clusters may include a visualization of the plurality of clusters. As another possibility, the indication may include a list of the plurality of clusters. Other example indications of the plurality of clusters are possible as well.

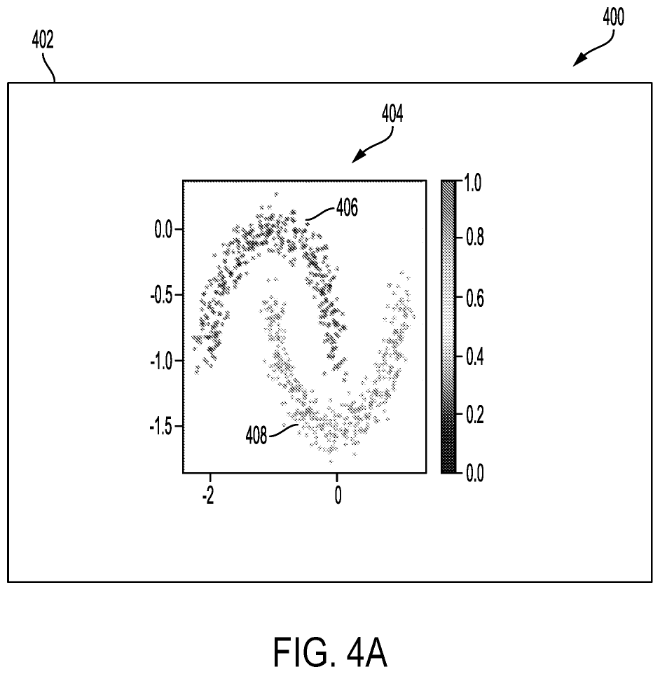

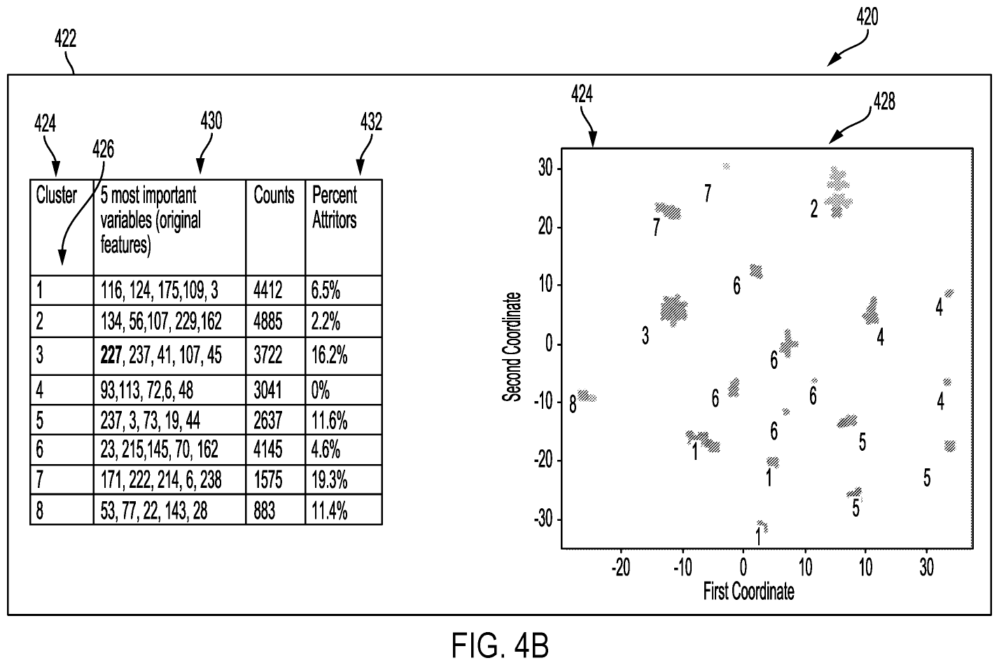

FIG. 4A depicts an example snapshot 400 of a GUI 402 that displays an indication 404 of a plurality of clusters. In this example, indication 404 is a visualization that illustrates a first cluster 406 and a second cluster 408.

FIG. 4B depicts another example snapshot 420 of a GUI 422 that displays an indication 424 of a plurality of clusters. In this example, indication 424 comprises a plurality of indicators for the plurality of clusters, including a list 426 of the clusters and a visualization 428 of the clusters. Other examples are possible as well.

After identifying the plurality of clusters associated with the set of data points, computing platform 102 may derive insights for the clusters.

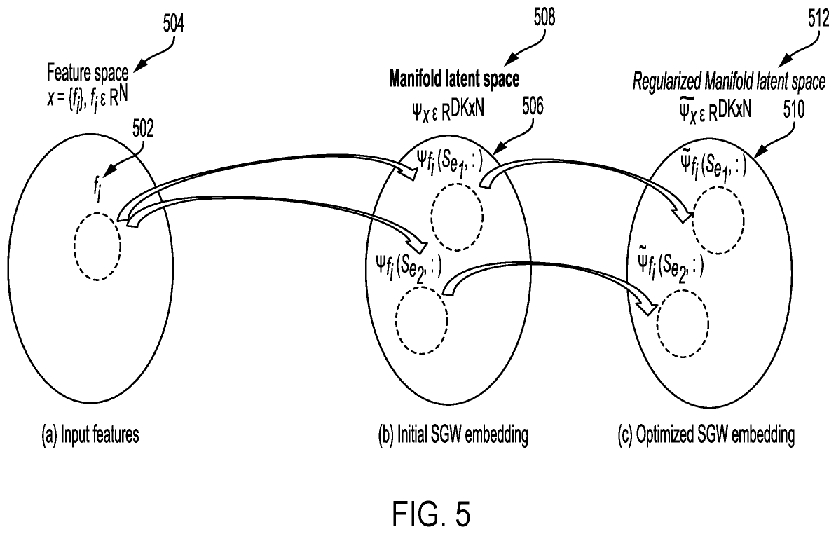

As indicated above, the clustering results are obtained based on a representation that is derived from the feature space. Further, the feature space comprises a plurality of original points, and each original point is associated with a plurality of feature dimensions. Still further, the regularized multi-scale representation comprises a plurality of coordinates, and each respective coordinate in the regularized multi-scale representation corresponds to a corresponding original feature dimension of the feature space. For instance, FIG. 5 illustrates a conceptual illustration of a linking between the original feature space and the regularized multi-scale representation. In particular, as indicated in FIG. 5, for the feature space 504, each original feature dimension 502 in the feature space 504 is linked to coordinates 506 of the initial embedding 508, each of which in turn is linked to a respective coordinate 510 of the optimized/regularized embedding 512. In other words, each coordinate in the learned latent manifold space can be mapped to its corresponding feature dimension (an arbitrary coordinate).

For simplicity, FIG. 5 illustrates example links from (i) a single arbitrary feature dimension fᵢ, (ii) to the initial embedding, (iii) to the optimized/regularized embedding. However, it should be understood that different links exist for each original feature dimension. As indicated above, the number of original feature dimensions will depend on the particular data set. For instance, within examples, the number of original feature dimensions may be a number within a range of 2-1,000. As a particular illustrative example, a given data set may have 250 original feature dimensions. As such, in this particular illustrative example, each original feature dimension of the 250 dimensions may in turn be linked to coordinates 506 of the initial embedding 508, each of which in turn is linked to a respective coordinate 510 of the optimized/regularized embedding 512.

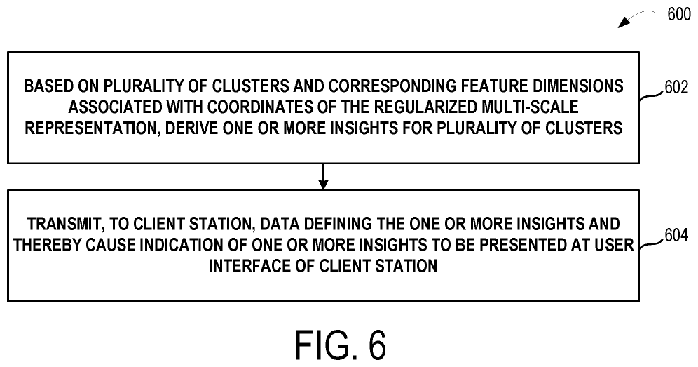

The plurality of clusters and the corresponding feature dimensions associated with the coordinates of the regularized multi-scale representation may be used to derive one or more insights for the clusters. FIG. 6 depicts one example of a process 600 that may be carried out in accordance with the disclosed technology in order to derive one or more insights for a plurality of clusters and present the one or more insights. For purposes of illustration only, example process 600 is described as being carried out by computing platform 102 of FIG. 1, but it should be understood that example process 600 may be carried out by computing platforms that take other forms as well. Further, it should be understood that, in practice, the functions described with reference to FIG. 6 may be encoded in the form of program instructions that are executable by one or more processors of computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

The example process 600 may begin at block 602 with computing platform 102 deriving, based on the plurality of clusters and the corresponding feature dimensions associated with the coordinates of the regularized multi-scale representation, one or more insights for the plurality of clusters.

In general, the one or more insights for the clusters may be related to the original features of the feature space. Various insights related to the original features of the feature space are possible. As one possibility, an insight may be an indication of the most important features for one or more clusters. In this regard, computing platform 102 may be configured to determine what, if any, original features have a threshold level of significance for the cluster. Further, the threshold level of significance may take various forms. For instance, computing platform 102 may determine that n original feature has a threshold level of significance if it appears a threshold percentage of the time (e.g., for 25% or more). As another example, computing platform may identify how often each feature appears for the points in the cluster, and determine a set of features that appear most often for the cluster (e.g., the top five features) and treat that set as the features having a threshold level of significance.

As another possibility, an insight may be an indication of all of the original features associated with the cluster.

Other insights related to the original features of the feature space are possible as well.

In some examples, the one or more insights for the clusters may include one or more insights for each cluster of the plurality of identified clusters. For instance, in an example, computing platform 102 may, for each respective cluster of the plurality of clusters, identify one or more original feature dimensions from the original feature space that have a threshold level of significance for the respective cluster. In other examples, the one or more insights for the clusters may include insights for a subset of clusters from the plurality of clusters. For instance, in an example, computing platform 102 may for each respective cluster of a subset of the plurality of clusters, identify one or more original feature dimensions from the original feature space that have a threshold level of significance for the respective cluster.

Within examples, the function of deriving the insights based on original features may be based on a Shapley analysis. In this regard, in some examples, in order to derive the insights based on original features, computing platform 102 may (i) for each respective cluster, assign a respective clustering label to the cluster and (ii) use the assigned clustering labels to derive the one or more insights for the plurality of clusters. These clustering labels may be utilized in a Shapley analysis. For instance, in an example where the coordinates of the representation comprise regularized wavelet coefficients, computing platform 102 may be configured to (i) for each respective cluster, assign a respective clustering label to the cluster; (ii) determine Shapley values of the regularized wavelet coefficients by using the assigned clustering labels and employing a Shapley algorithm; and (iii) based on the determined Shapley values and the corresponding original feature dimensions associated with the coordinates of the representation, identify, for each respective cluster of at least a subset of the plurality of clusters, respective one or more original features from the original feature space that have a threshold level of significance for the respective cluster. In order to apply the Shapley algorithm, a label is applied to each cluster (together with the features of the regularized embeddings). In an example, the input for the Shapley algorithm is similar to or simulates how a Shapley algorithm works in supervised learning (however, in the disclosed Shapely analysis, the labels of the clusters were obtained in an unsupervised way, and cluster assignment is similar to the class label in a supervised model). The Shapley algorithm then provides as an output the feature importance for each point in the (regularized) embeddings, which can then be linked to the original features as discussed with respect to FIG. 5.

As indicated above, respective one or more original features having a threshold level of significance may be identified for each cluster of a subset of the plurality of clusters. However, in some examples, computing platform 102 may identify, for each respective cluster of the plurality of clusters, respective one or more original features from the original feature space that have a threshold level of significance for the respective cluster.

As an illustrative example of using a Shapley analysis, computing platform 102 may use a clustering method such as K-means to partition the manifold into k clusters, Cⱼ. Computing platform 102 may let h(x) be the clustering label obtained after using a clustering method applied to the regularized wavelet embeddings. Further, computing platform 102 may then partition the regularized manifold coordinates [symbol] . In an example, computing platform may, using the partition from the clustering, assign to each point xⱼ a label h(xⱼ) associated with its corresponding cluster Cⱼ. Computing platform 102 may then use the cluster assignment h(xⱼ) as a pseudo label for each point in the manifold embedding space.

Computing platform 102 may then determine Shapley values approximation by approximating the Shapley values of the regularized wavelet coefficients [symbol] ={ [symbol] (sₑ,:)}, i=1, . . . D, e=1, . . . m by employing a Shapley algorithm to the regularized wavelet embedding { [symbol] , (sₑ,:)}.

Using Shapley values as an explanation framework enables measuring the importance of the features projected on the manifold. Based on these determined Shapley values and the corresponding original feature dimensions associated with the coordinates of the representation, computing platform 102 may identify one or more original features from the original feature space that have a threshold level of significance for the respective cluster. In this regard, the determined Shapley value approximations provides an indication of importance of the original features to the clusters, where a higher Shapley value represents a higher relative importance.

In some examples, computing platform 102 may take into account all of the original features when determining which one or more original features from the original feature space that have a threshold level of significance for the respective cluster. For instance, computing platform 102 may take into account all original features in a scenario where it is desired to provide interpretation for all the features. However, in other examples, computing platform 102 may (i) take into account a subset of the original features and (ii) and determine one or more original features from the subset of original features that have a threshold level of significance for the respective cluster. For instance, computing platform 102 may consider a subset of original features in a scenario where there may not be a desire to provide interpretation for certain features (e.g., if a certain feature(s) appear(s) to be associated with noise or is not relevant to the task or interpretation at hand).

Returning to FIG. 6, at block 604, computing platform 102, transmits, to a client station, data defining the one or more insights and thereby causes an indication of the one or more insights to be presented at a user interface of the client station. The indication of the one or more insights to be presented at the user interface of the client station may take various forms. An example indication of such insights is shown in FIG. 4B. For instance, GUI 422 includes an indication 430, which takes the form of, for each cluster, a list of the most important original features to that cluster. Other examples of indications of the insights are possible as well.

In some examples, the indication of the plurality of clusters and the indication of the one or more insights may be presented at the same time, such as in the GUI 422 shown in FIG. 4B. However, in other examples, the indication of the plurality of clusters and the indication of the one or more insights may be presented at different times. Additionally, in some examples, the indication of the plurality of clusters and the indication of the one or more insights may be presented at different client stations.

Computing platform 102 may also be configured to derive additional insights based on the identified most important features. These additional insights may take various forms and be determined in various ways. For instance, as one possibility, computing platform 102 may make predictions about future behavior of individuals based on the identified most important features for the clusters. As one example in the context of an organization that provides financial services to individuals, computing platform 102 may determine that a cluster is associated with individuals that have defaulted on a loan, and that the cluster is associated with a given set of most important features. Computing platform 102 may determine that a prospective customer is associated with each feature in the given set of important features, and based on that determination, predict that the prospective customer is likely to default on a loan. As another example, an insight may involve identifying, based on the identified most important features, customers who are currently in good standing but may be likely to default on a loan if the economy becomes worse (e.g., individuals impacted by inflation but have no prior default information available).

As another possibility, computing platform 102 may use the identified most important features to determine customers to which to market a good and/or service that is provided by an organization. For instance, as one example, a cluster of individuals that are likely to utilize a given service may be associated with a given set of most important features. Computing platform 102 may determine that a prospective customer is associated with each feature in the given set of important features, and based on that determination, target the prospective customer when engaging in marketing of a good and/or service that is provided by the organization.

As yet another possibility, computing platform 102 may use the identified most important features and ground truth labels to derive additional insights. For instance, in an example, computing platform 102 may identify ground truth labels for individuals in the clustering results, and then use the ground truth labels and most important features to derive insights about the data. For instance, individuals that cancelled a given service provided by an organization (which may be referred to as “attritors”) may be labeled with ground truth labels. Computing platform 102 may then determine that a plurality of clusters had a high number of labeled attritors, and based on that analysis determine features associated with attritors. In this regard, in the example of FIG. 4B, ground truth labels were applied to the points in the eight (8) clusters to identify the attritors in each cluster. Based on these ground truth labels, it is possible to determine the percent of data points in each cluster that correspond to attritors, as indicated in column 432. Further, in the example of FIG. 4B, the clusters having the highest percentages of attritors (e.g., clusters 3, 5, 7, and 8) and the corresponding most important original features from those clusters may be analyzed to determine the original features most frequently associated with attritors. Other examples are possible as well.

In some examples, the clustering results, ground truth labels, and/or identified most important features may be used as a check on supervised learning applications as well as semi-supervised settings. Further, in some examples, the embedding results (before clustering) may be used in downstream tasks such as supervised learning.

Other additional insights based on the identified most important features are possible as well.

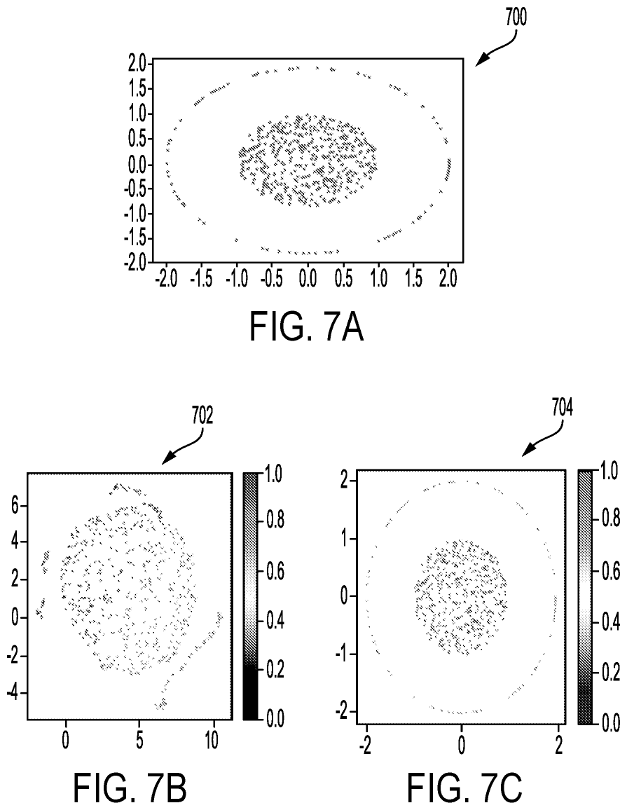

As indicated above, the disclosed technology provides several advantages over existing technology for clustering and manifold learning. For instance, the disclosed technology provides improved clustering results compared to existing technology. More particularly, the disclosed technology involves crafting manifold embeddings that notably enhance the efficiency of downstream tasks, such as clustering. In this regard, examples demonstrating improved clustering using the disclosed technology compared to clustering using existing technology are described with reference to FIGS. 7A-11B. The existing technology to which the disclosed technology was compared in these experiments is UMAP.

As a first experimental example, both existing UMAP technology and the disclosed technology were applied to a data set representing a dense circle inside a sparse circle. With reference to FIGS. 7A-C, a comparison between these figures demonstrates improved clustering using the disclosed technology compared to clustering using existing technology. FIG. 7A illustrates a visualization 700 of input data, which includes a dense circle inside a sparse circle. Further, FIG. 7B illustrates a visualization 702 of clustering obtaining using UMAP, and FIG. 7C illustrates a visualization 704 of clustering obtaining using the disclosed technology. In this example, N=500 points (using a uniform distribution) were randomly sampled from a dense circle with radius r=1, and N=100 were randomly sampled from a second sparse circle with radius r=2. Further, k=15 was used as the parameter for kNN-nearest neighbor graph construction. As can be seen from FIG. 7B, the existing technology failed to find an embedding that reflects the correct segmentation. A potential reason or explanation for this failure is that UMAP heavily relies on the local distances used in the initial graph construction, which results in connecting some points in the inner circle with points in the outer circle. On the other hand, as shown in FIG. 7C, the clustering obtained using the disclosed technology reflects the correct segmentation. Notably, the multi-scale representation of the disclosed technology captures smoothness simultaneously in the local graph vertex and spectral domains, which is useful to distinguish these two clusters. This example highlights an example advantage of the disclosed technology in comparison to UMAP-robustness to effective embedding when clusters have different densities, which is important for practical applications. In financial data sets, different clusters or groups may be imbalanced, corresponding to different groups that may contain different densities.

As a second experimental example, both the existing UMAP technology and the disclosed technology were applied to a data set representing “two moons” data, which is a popular example used in literature to test and evaluate clustering methods. This second experimental example may be referred to herein as a “two-moons experiment.”

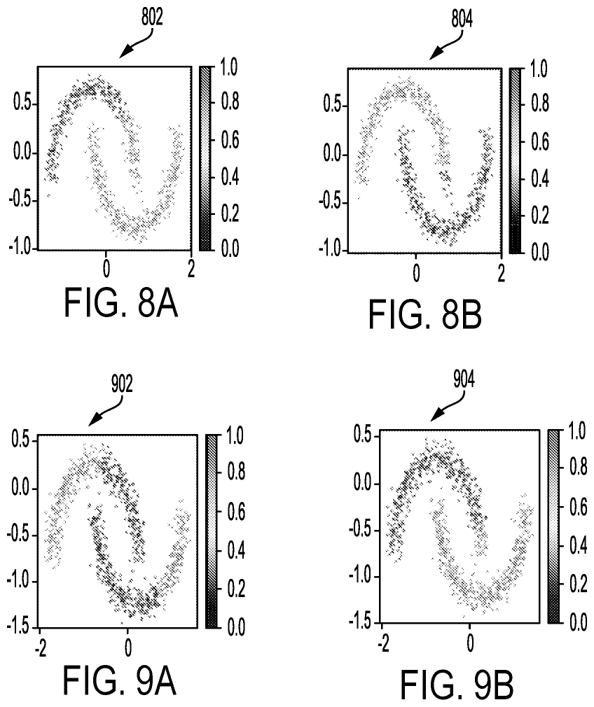

In this two-moons experiment, a varied selection of k (the nearest neighbors' parameter for the graph construction) was used. The disclosed technology was compared to the existing technology of UMAP (using the same parameters for the graph construction). Four versions of this two-moons experiment are described below, and cluster results for these versions of the two-moons experiment are shown in FIGS. 8A-11B. For the spectral graph wavelet transform parameters, j=5 scales was used for each version. The highest frequency band J=5, in which noise dominates, was discarded and set to zero. The multi-scale approach optimized using gradient descent to minimize the cross entropy loss (CE) directly in the wavelet embedding space as described above with reference to block 206 of FIG. 2. A different number of iterations were used in versions 1-4 and, in particular, iterations between 100-1000 for the CE loss. Notably, using more iterations increased the running time while improving accuracy of segmentation. In all versions, k-means was used to cluster the data in the embedding space. The two moons manifolds were sampled using a Scikit learn toolbox to which different amounts of gaussian noise were added.

Turning to the first version of this two-moons experiment, N=800 points were randomly sampled from two moons manifolds. Further, k=15 was used as the parameter for the k nearest neighbor for graph construction, and gaussian noise was added in all dimensions with std=0.075. Results of this first version of this two-moons experiment are illustrated in FIGS. 8A-B. In particular, FIG. 8A illustrates a visualization 802 of clustering obtained using UMAP and FIG. 8B illustrates a visualization 804 of clustering obtained using the disclosed technology. For clarity, these clustering results are shown on the original input set of points for visualization purposes. As can be seen by comparing the visualizations 802 and 804, the disclosed technology performed better than UMAP in classifying the two manifolds.

Further, in a second version of this two-moons experiment, the number of points sampled was increased to N=1000 and more noise was added (std=0.9). Further, k=15 was used for the k nearest neighbor graph parameter. Results of this second version are illustrated in FIGS. 9A-B. In particular, FIG. 9A illustrates a visualization 902 of clustering obtained using UMAP and FIG. 9B illustrates a visualization 904 of clustering obtained using the disclosed technology. As can be seen by comparing the visualizations 902 and 904, the disclosed technology again performed better than UMAP in classifying the two manifolds.

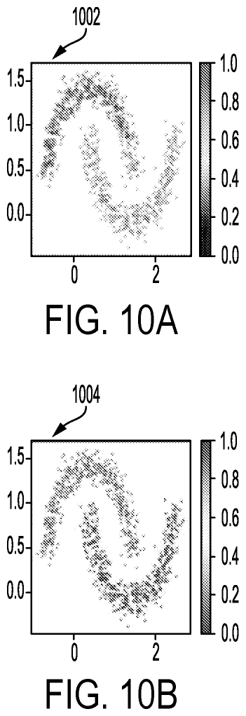

Still further, in a third version of this two-moons experiment, N=1000 points were sampled, and more noise was added (std=0.1). Further, k=20 was used for the k nearest neighbor graph parameter. Results of this third version are illustrated in FIGS. 10A-B. In particular, FIG. 10A illustrates a visualization 1002 of clustering obtained using UMAP and FIG. 10B illustrates a visualization 1004 of clustering obtained using the disclosed technology. As can be seen by comparing the visualizations 1002 and 1004, the disclosed technology again performed better than UMAP in classifying the two manifolds.

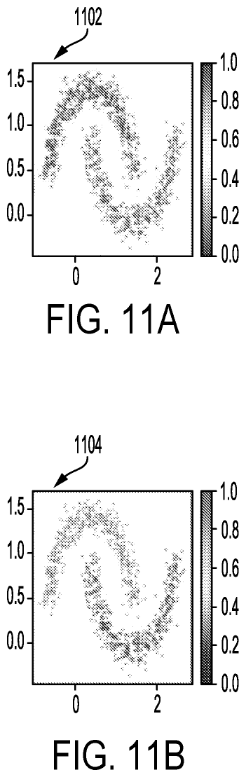

Yet still further, in a fourth version of this two-moons experiment, N=800 points were sampled, and noise was added (std=0.1). Further, k=25 was used for the k nearest neighbor graph parameter. Results of this fourth version are illustrated in FIGS. 11A-B. In particular, FIG. 11A illustrates a visualization 1102 of clustering obtained using UMAP and FIG. 11B illustrates a visualization 1104 of clustering obtaining using the disclosed technology. As with the other examples above, the disclosed technology performed better than UMAP in classifying the two manifolds

Comparisons between these figures reveals, for each version, improved clustering results using the disclosed technology compared to clustering using existing technology. Notably, this two-moons experiment demonstrates that UMAP appears to be more sensitive to the parameter's choice and higher levels of noise. Further, while UMAP and other graph methods such as spectral clustering may perform well on the two moons data with low or modest amount of noise, these existing approaches often do not correctly cluster the two manifolds in the presence of a large amount of noise.

In addition to the improved clustering, the disclosed technology provides improved interpretability for the clusters and the data sets. The disclosed technology helps to improve the robustness of a manifold representation. The output of the algorithm provides regularized manifold embeddings that can be traced back to the original input features. This correspondence between the original features and the latent manifold representation enables an organization to measure the importance of the features projected on the manifold by using Shapley values as an explanation framework. By providing such interpretation, the disclosed approach overcomes a limitation of current manifold learning approaches and offers a new way to understand the relationships between the manifold global structure and the source data features. Notably, this has potentially significant implications for improving the interpretability of manifold learning algorithms and can lead to better insights and understanding of the underlying data structure.

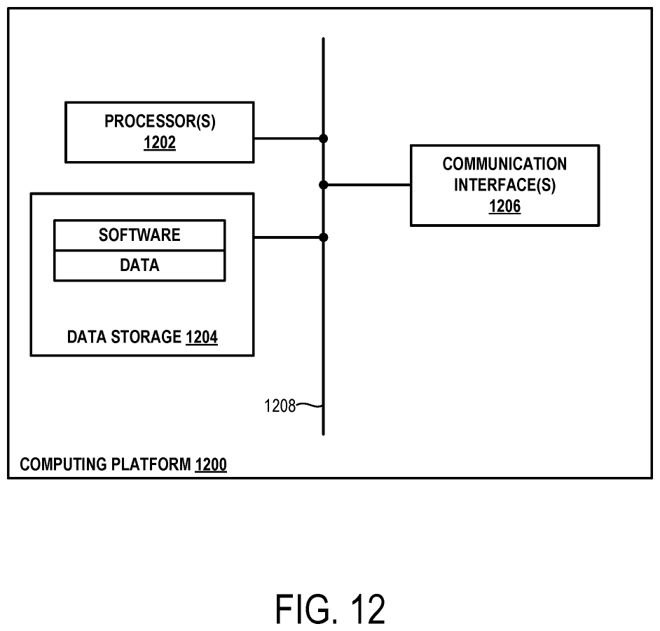

Turning now to FIG. 12, a simplified block diagram is provided to illustrate some structural components that may be included in an example computing platform 1200 that may be configured to perform some or all of the functions discussed herein for clustering and manifold learning in accordance with the present disclosure. At a high level, computing platform 1200 may generally comprise any one or more computer systems (e.g., one or more servers) that collectively include one or more processors 1202, data storage 1204, and one or more communication interfaces 1206, all of which may be communicatively linked by a communication link 1208 that may take the form of a system bus, a communication network such as a public, private, or hybrid cloud, or some other connection mechanism. Each of these components may take various forms.

For instance, the one or more processors 1202 may comprise one or more processor components, such as one or more central processing units (CPUs), graphics processing units (GPUs), application-specific integrated circuits (ASICs), digital signal processor (DSPs), and/or programmable logic devices such as a field programmable gate arrays (FPGAs), among other possible types of processing components. In line with the discussion above, it should also be understood that the one or more processors 1202 could comprise processing components that are distributed across a plurality of physical computing devices connected via a network, such as a computing cluster of a public, private, or hybrid cloud.

In turn, data storage 1204 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 1204 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 12, data storage 1204 may be capable of storing both (i) program instructions that are executable by processor 1202 such that the computing platform 1200 is configured to perform any of the various functions disclosed herein (including but not limited to any the functions described above with reference to FIG. 2 and FIG. 6), and (ii) data that may be received, derived, or otherwise stored by computing platform 1200.

The one or more communication interfaces 1206 may comprise one or more interfaces that facilitate communication between computing platform 1200 and other systems or devices, where each such interface may be wired and/or wireless and may communicate according to any of various communication protocols, examples of which may include Ethernet, Wi-Fi, serial bus (e.g., Universal Serial Bus (USB) or Firewire), cellular network, and/or short-range wireless protocols, among other possibilities.

Although not shown, the computing platform 1200 may additionally include or have an interface for connecting to one or more user-interface components that facilitate user interaction with the computing platform 1200, such as a keyboard, a mouse, a trackpad, a display screen, a touch-sensitive interface, a stylus, a virtual-reality headset, and/or one or more speaker components, among other possibilities.

It should be understood that computing platform 1200 is one example of a computing platform that may be used with the embodiments described herein. Numerous other arrangements are possible and contemplated herein. For instance, other computing systems may include additional components not pictured and/or more or less of the pictured components.

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

1. A computing platform comprising:
a communication interface;
at least one processor;
at least one non-transitory computer-readable medium; and
program instructions stored on the at least one non-transitory computer-readable medium that are executable by the at least one processor to cause the computing platform to:
based on a set of data points defining a feature space, construct a graph structure associated with the set of data points;
generate a multi-scale representation that represents the feature space, wherein each feature of a plurality of features from the feature space is represented in a respective plurality of scales with respect to the graph structure;
regularize the multi-scale representation;
based on the regularized multi-scale representation, identify a plurality of clusters associated with the set of data points; and
transmit, to a client station, data regarding the plurality of clusters and thereby cause an indication of the plurality of clusters to be presented at a user interface of the client station.

2. The computing platform of claim 1, wherein the graph structure comprises a graph Laplacian, and wherein the program instructions that are executable by the at least one processor to cause the computing platform to generate a multi-scale representation that represents the feature space, wherein each feature of a plurality of features from the feature space is represented in a respective plurality of scales with respect to the graph structure comprise program instructions stored on the at least one non-transitory computer-readable medium that are executable by the at least one processor to cause the computing platform to:
compute coefficients corresponding to a polynomial approximation for a Spectral Graph Wavelets (SGW) transform of the graph Laplacian; and
initialize multi-scale graph embedding coordinates for the multi-scale representation by computing a respective SGW for each coordinate dimension.

3. The computing platform of claim 1, wherein the multi-scale representation represents signal of the multi-scale representation in a vertex domain and a spectral domain.

4. The computing platform of claim 1, wherein the program instructions that are executable by the at least one processor to cause the computing platform to regularize the multi-scale representation comprise program instructions stored on the at least one non-transitory computer-readable medium that are executable by the at least one processor to cause the computing platform to:
optimize features of the multi-scale representation by using stochastic gradient descent with respect to the graph structure.

5. The computing platform of claim 1, wherein the program instructions that are executable by the at least one processor to cause the computing platform to regularize the multi-scale representation comprise program instructions stored on the at least one non-transitory computer-readable medium that are executable by the at least one processor to cause the computing platform to:
for each respective feature of the multi-scale representation, (i) concatenate scales and feature dimensions corresponding to the respective feature and (ii) optimize the respective feature of the multi-scale representation using the concatenated scales and feature dimensions corresponding to the respective feature.

6. The computing platform of claim 1, wherein the program instructions that are executable by the at least one processor to cause the computing platform to regularize the multi-scale representation comprise program instructions stored on the at least one non-transitory computer-readable medium that are executable by the at least one processor to cause the computing platform to:
for each respective feature of the multi-scale representation:
for each respective scale of the multi-scale representation, (i) concatenate feature dimensions corresponding to the respective feature and (ii) optimize the respective feature for the respective scale using the concatenated feature dimensions corresponding to the respective feature.

7. The computing platform of claim 1, wherein the program instructions that are executable by the at least one processor to cause the computing platform to, based on the regularized multi-scale representation, identify a plurality of clusters associated with the set of data points comprise program instructions stored on the at least one non-transitory computer-readable medium that are executable by the at least one processor to cause the computing platform to:
use an unsupervised machine learning model to output the plurality of clusters.

8. The computing platform of claim 1, wherein:
the feature space comprises a plurality of original points;
each original point is associated with a plurality of feature dimensions;
the regularized multi-scale representation comprises a plurality of coordinates;
each respective coordinate in the regularized multi-scale representation is associated with a corresponding feature dimension of the feature space; and
the program instructions are further executable by the at least one processor to cause the computing platform to:
based on the plurality of clusters and the corresponding feature dimensions associated with the coordinates of the regularized multi-scale representation, derive one or more insights for the plurality of clusters.

9. The computing platform of claim 8, wherein the program instructions that are executable by the at least one processor to cause the computing platform to, based on the plurality of clusters and the corresponding feature dimensions associated with the coordinates of the regularized multi-scale representation, derive one or more insights for the plurality of clusters comprise program instructions stored on the at least one non-transitory computer-readable medium that are executable by the at least one processor to cause the computing platform to:
for each respective cluster of the plurality of clusters, identify one or more feature dimensions from the feature space that have a threshold level of significance for the respective cluster.

10. The computing platform of claim 8, wherein:
the computing platform further comprises program instructions that are executable by the at least one processor to cause the computing platform to:
for each respective coordinate in the regularized multi-scale representation, identifying a respective corresponding feature dimension of the feature space associated with the respective coordinate; and
the program instructions that are executable by the at least one processor to cause the computing platform to regularize the multi-scale representation to, based on the plurality of clusters and the corresponding feature dimensions associated with the coordinates of the regularized multi-scale representation, derive one or more insights for the plurality of clusters comprise program instructions stored on the at least one non-transitory computer-readable medium that are executable by the at least one processor to cause the computing platform to:
based on the plurality of clusters and the identified corresponding feature dimensions of the feature space associated with the respective coordinates, derive one or more insights for the plurality of clusters.

11. The computing platform of claim 8, wherein the program instructions that are executable by the at least one processor to cause the computing platform to, based on the plurality of clusters and the corresponding feature dimensions associated with the coordinates of the regularized multi-scale representation, derive one or more insights for the plurality of clusters comprise program instructions stored on the at least one non-transitory computer-readable medium that are executable by the at least one processor to cause the computing platform to:
for each respective cluster, assign a clustering label to the respective cluster; and
use the assigned clustering labels to derive the one or more insights for the plurality of clusters.

12. The computing platform of claim 11, wherein:
the coordinates of the regularized multi-scale representation comprise regularized wavelet coefficients; and
the program instructions that are executable by the at least one processor to cause the computing platform to use the assigned clustering labels to derive the one or more insights for the plurality of clusters comprise program instructions stored on the at least one non-transitory computer-readable medium that are executable by the at least one processor to cause the computing platform to:
determine Shapley values of the regularized wavelet coefficients by using the assigned clustering labels and employing a Shapley algorithm to the regularized multi-scale representation; and
based on the determined Shapley values and the corresponding original feature dimensions associated with the coordinates of the regularized multi-scale representation, identify, for each respective cluster of at least a subset of the plurality of clusters, respective one or more original features from the original feature space that have a threshold level of significance for the respective cluster.

13. The computing platform of claim 8, wherein the computing platform further comprises program instructions that are executable by the at least one processor to cause the computing platform to:
transmit, to a second client station, data defining the one or more insights and thereby cause an indication of the one or more insights to be presented at a user interface of the second client station.

14. The computing platform of claim 13, wherein the client station and the second client station are the same client station.

15. The computing platform of claim 14, wherein the indication of the plurality of clusters and the indication of the one or more insights are presented at a same time.

16. A non-transitory computer-readable medium, wherein the non-transitory computer-readable medium is provisioned with program instructions that, when executed by at least one processor, cause a computing platform to:
based on a set of data points defining a feature space, construct a graph structure associated with the set of data points;
generate a multi-scale representation that represents the feature space, wherein each feature of a plurality of features from the feature space is represented in a respective plurality of scales with respect to the graph structure;
regularize the multi-scale representation;
based on the regularized multi-scale representation, identify a plurality of clusters associated with the set of data points; and
transmit, to a client station, data regarding the plurality of clusters and thereby cause an indication of the plurality of clusters to be presented at a user interface of the client station.

17. The non-transitory computer-readable medium of claim 16, wherein:
the feature space comprises a plurality of original points;
each original point is associated with a plurality of feature dimensions;
the regularized multi-scale representation comprises a plurality of coordinates;
each respective coordinate in the regularized multi-scale representation is associated with a corresponding feature dimension of the feature space; and
the non-transitory computer-readable medium is also provisioned with program instructions that, when executed by at least one processor, cause the computing platform to:
based on the plurality of clusters and the corresponding feature dimensions associated with the coordinates of the regularized multi-scale representation, derive one or more insights for the plurality of clusters.

18. The non-transitory computer-readable medium of claim 17, wherein the program instructions that, when executed by the at least one processor, cause the computing platform to, based on the plurality of clusters and the corresponding feature dimensions associated with the coordinates of the regularized multi-scale representation, derive one or more insights for the plurality of clusters comprise program instructions that, when executed by the at least one processor, cause the computing platform to:
for each respective cluster of the plurality of clusters, identify one or more feature dimensions from the feature space that have a threshold level of significance for the respective cluster.

19. A method carried out by a computing platform, the method comprising:
based on a set of data points defining a feature space, constructing a graph structure associated with the set of data points;
generating a multi-scale representation that represents the feature space, wherein each feature of a plurality of features from the feature space is represented in a respective plurality of scales with respect to the graph structure;
regularizing the multi-scale representation;
based on the regularized multi-scale representation, identifying a plurality of clusters associated with the set of data points; and
transmitting, to a client station, data regarding the plurality of clusters and thereby causing an indication of the plurality of clusters to be presented at a user interface of the client station.

20. The method of claim 19, wherein:
the feature space comprises a plurality of original points;
each original point is associated with a plurality of feature dimensions;
the regularized multi-scale representation comprises a plurality of coordinates;
each respective coordinate in the regularized multi-scale representation is associated with a corresponding feature dimension of the feature space; and
the method further comprises, based on the plurality of clusters and the corresponding feature dimensions associated with the coordinates of the regularized multi-scale representation, deriving one or more insights for the plurality of clusters.
